(19) United States
(12) Patent Application Publication
(10) Pub. No.: US 2003/0167608 A1
(43) Pub. Date: Sep. 11, 2003

(54) Snap-hook equipped with a locking ring with a separating bar

(75) Inventors: Paul Petzl, Barraux (FR); Anne Bauvois, Laval (FR)

Correspondence Address: OLIFF & BERRIDGE, PLC, P.O. BOX 19928, ALEXANDRIA, VA, 22320, US

(73) Assignee: ZEDEL, Crolles (FR)

(21) Appl. No.: 10/370,697

(22) Filed: Feb. 24, 2003

(30) Foreign Application Priority Data
Mar. 11, 2002 (FR) 0203017

(51) Int. Cl. F16B 45/02

(52) U.S. Cl. 24/600.2

(57) ABSTRACT

A snap-hook comprising a fixed hollow C-shaped body, a mobile finger pivoting around a spindle, and an operating ring mounted around the finger between a first locked position for positive locking of the finger in the closed position, and a second unlocked position enabling the finger to move to the open position. The operating ring is equipped with a bar salient from the lateral surface to come, in the first locked position, up against the part of the fixed body situated facing the finger arranging two openings in the body. In the second unlocked position, the bar is situated in a different plane from that of the body and defines a single opening in the snap-hook.

### BACKGROUND OF THE INVENTION

The invention relates to a snap-hook comprising:

a fixed hollow C-shaped body having a first end shaped as a retaining part, and a second end for articulation of a mobile finger pivoting around a spindle between a closed position and an open position,

an operating ring mounted around the finger between a first locked position for positive locking of the finger in the closed position, and a second unlocked position enabling the finger to move to the open position, said ring being able to be moved manually to go from the first locked position to the second unlocked position, and vice-versa.

### STATE OF THE ART

A snap-hook with a locking ring with a mobile finger is known from the document EP 0,826,890.

To prevent the snap-hook from turning on the rope when acting as means for attachment to the harness, it is known from the document EP 0,976,936 to use a connector articulated on the fixed body and able to be folded onto the finger so as to increase the safety and mechanical strength. The connector has to be fitted manually after the finger has been closed. Safety is nevertheless not guaranteed if the connector is forgotten or is positioned incorrectly on the finger.

### OBJECT OF THE INVENTION

The object of the invention consists in providing a snap-hook with a locking ring benefiting from optimum safety and mechanical strength in the closed position of the finger.

The device according to the invention is characterized in that the operating ring is equipped with a bar salient from the lateral surface to automatically come up against the part of the fixed body situated facing the finger arranging two openings in the body in the first locked position, and that in the second unlocked position, said bar is situated in a different plane from that of the body and defines a single opening in the snap-hook.

The presence of the two openings in the first locked position avoids the consequences of the snap-hook working askew.

According to one feature of the invention, the operating ring is equipped with an aperture wherein a pin of the finger engages to determine the angular movement when movement of said ring takes place.

According to one feature of the invention, the aperture comprises two grooves to make the ring bistable in both the locked and the unlocked position.

According to an alternative embodiment, the aperture is arranged to make the ring monostable in the locked position.

### BRIEF DESCRIPTION OF THE DRAWINGS

Other advantages and features will become more clearly apparent from the following description of an embodiment of the invention given as a non-restrictive example only and represented in the accompanying drawings, in which:

FIGS. 1 and 2 are perspective views of the snap-hook according to the invention, the ring being in the closed locked position;

FIG. 3 shows a vertical cross-sectional view of the snap-hook of FIG. 1;

FIG. 4 represents a view of a detail of the locking ring of FIG. 2;

FIGS. 5 to 9 illustrate the successive phases of operation of the snap-hook when opening takes place;

FIG. 10 shows an alternative embodiment of the snap-hook;

FIGS. 11 and 12 represent another alternative embodiment of the snap-hook, respectively in the locked position and in the unlocked position;

FIG. 13 represents a view of a detail of the locking ring of FIG. 11.

### DESCRIPTION OF THE PREFERRED EMBODIMENT

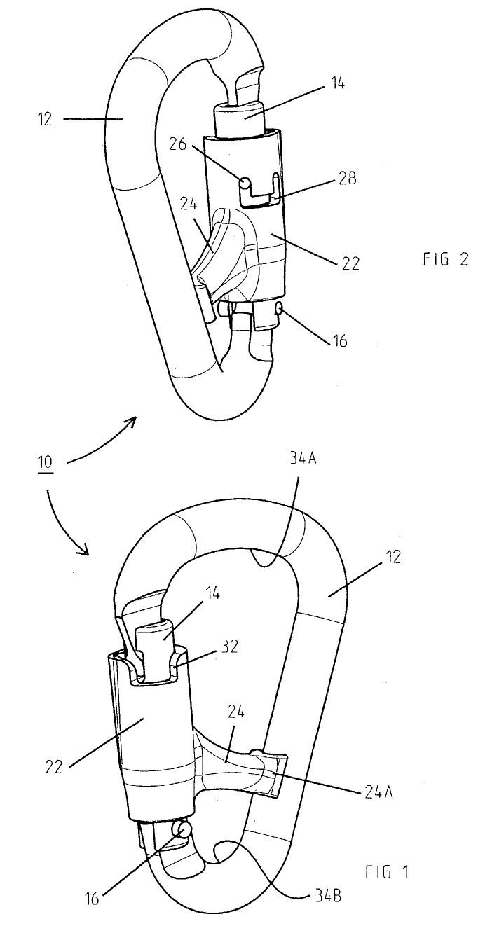

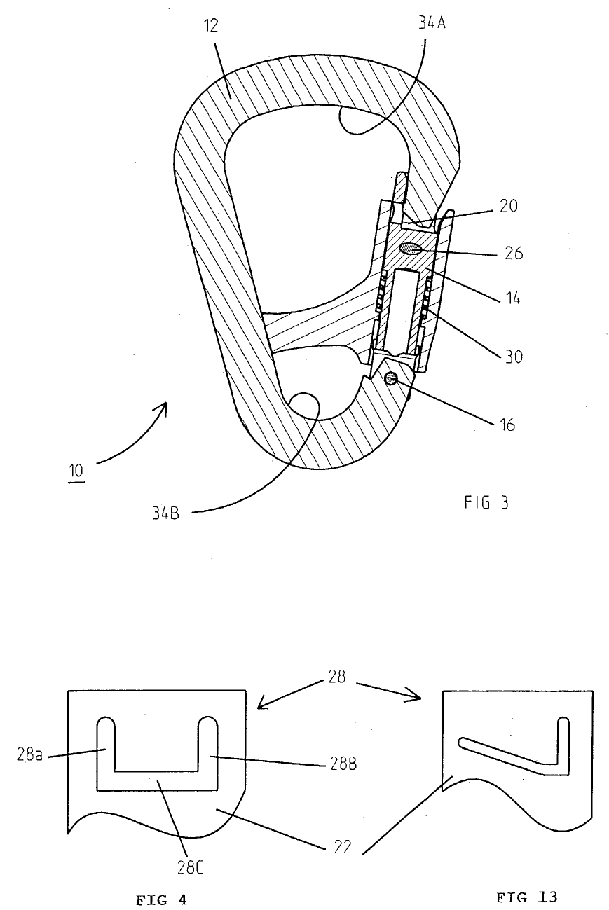

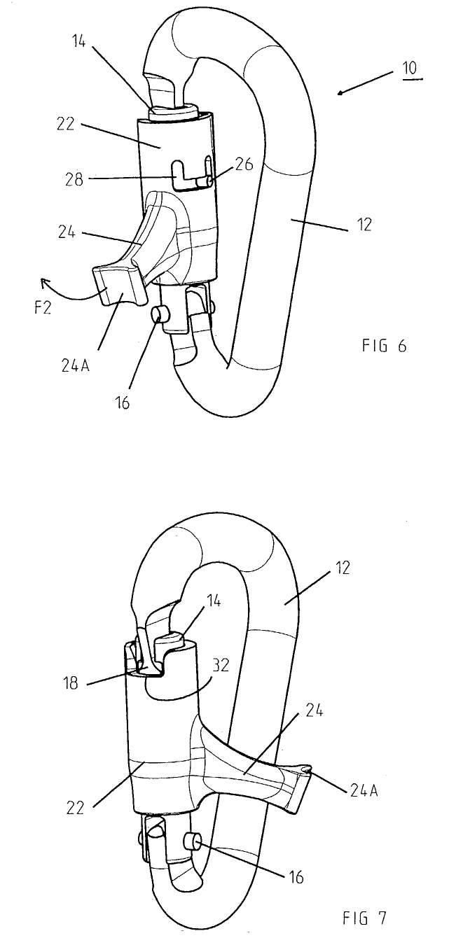

With reference to FIGS. 1 to 9, a snap-hook 10 comprises a fixed hollow C-shaped body 12 and a mobile finger 14 of circular cross-section that is pivotally mounted on a spindle 16 of the body 12 between a closed position and an open position. Movement of the finger 14 to the open position is performed towards the inside of the body 12 so as to arrange a gap for a rope or any other belaying means to pass. The articulated finger 14 is biased to the closed position by means of a return spring (not shown).

In the closed position of the snap-hook 10, a protuberance 18 at the end of the body 12 constitutes a retaining part which engages in a blind orifice 20 of the finger 14.

This orifice 20 is arranged as a latching member situated opposite the spindle 16 and cooperating with the retaining part to form a keyhole link able to withstand large tensile stresses.

An operating ring 22 is fitted coaxially on the mobile finger 14 and is able to be moved angularly between a first locked position and a second unlocked position. The length of the operating ring 22 is shorter than that of the finger 14 that it surrounds. It comprises in addition a strengthening bar 24 salient from the lateral surface so as to come up against the body 12 in the locked position when the snap-hook 10 is closed. The end of the bar 24 is provided for this purpose with a curved bearing face 24A designed to fit snugly on the internal part of the body 12.

In this closed locked position represented in FIGS. 1 to 3, it is impossible to move the finger 14 to the open position following the double mechanical locking performed by the operating ring 22 and the bar 24.

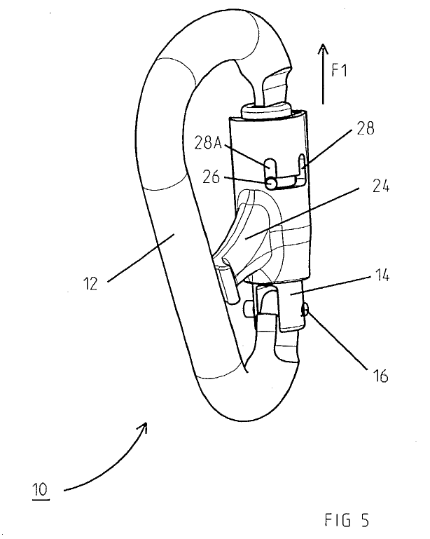

The finger 14 is equipped in addition with a radial spigot 26 engaged in an aperture 28 of the rotary ring 22 to render it bistable in both the locked and the unlocked positions. The U-shaped aperture 28 (FIG. 4) comprises two vertical grooves 28A, 28B joined to one another by an appreciably horizontal slot 28C. The distance between the two grooves 28A, 28B determines the angular movement of the operating ring 22, and a coil spring 30 biases this ring to the locked position as soon as the spigot 26 is at the level of the slot 28C.

A half-open notch 32 is arranged at the end of the ring 22 to free the keyhole in the unlocked position. The finger 14 can then be pushed towards the inside of the body 12 to open the snap-hook 10.

Operation of the snap-hook 10 according to FIGS. 1 to 9 is as follows:

In FIGS. 1 to 3, the finger 14 is in the closed position and the operating ring 22 is in the locked position so as to block off the keyhole of the snap-hook. The spigot 26 is held at the bottom of the groove 28A by the return action of the spring 30. This position is perfectly stable and the bar 24 bears on the inside wall of the body 12 to form a second latching which enhances the mechanical strength in the closed position. The bar subdivides the inside of the snap-hook 10 into two openings 34A, 34B of different sizes. The belaying means (for example a jammer or a descender) are fixed in one of the openings and can not be diverted to the other opening housing a rope. There is therefore less stress on the finger 14 according to the different orientations of the snap-hook 10. The presence of the two openings 34A, 34B only allows a single stress along the main axis and therefore avoids the consequences of the snap-hook working askew.

To unlock the ring 22, the latter simply has to be pushed upwards (arrow F1, FIG. 6) so as to release the spigot 26 from the groove 28A. The ring 22 is then moved in rotation in the direction of the arrow F2 (FIG. 8) until the spigot 26 reaches the end of travel of the slot 28C. In this intermediate position, the notch 32 of the ring 22 is partly facing the keyhole but still prevents opening of the finger 14 (FIG. 7). The bar 24 fixedly secured to the ring 22 moves away from the body 12 when this rotation movement takes place.

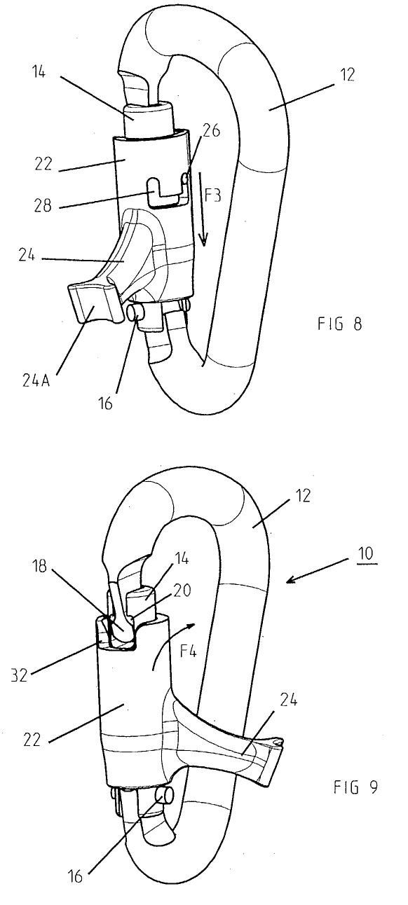

Unlocking of the finger 14 takes place by lowering the ring 22 (arrow F3, FIG. 10) causing the spigot 26 to reach the bottom of the groove 28B. In this stable position of the ring 22, the notch 32 releases the keyhole (FIG. 9) completely, allowing the finger 14 to be moved inwards (arrow F4) to perform opening of the snap-hook 10.

It is clear that the locking system of the ring 22 may be different, either by modifying the shape of the aperture 28 for example making it L-shaped to make the ring 22 monostable in the locked position, or by replacing the spigot 26 by other locking means for example with balls.

According to FIG. 10, the U-shaped aperture 28 is arranged at the bottom part of the operating ring 22, and the pivoting spindle 16 constitutes the spigot which engages in the aperture 28. In this alternative version, the protuberance 18 and orifice 20 are eliminated, the ends of the body 12 and of the finger 14 simply coming up against one another in the closed position. A single mechanical locking of the finger 14 in the closed position is thus obtained.

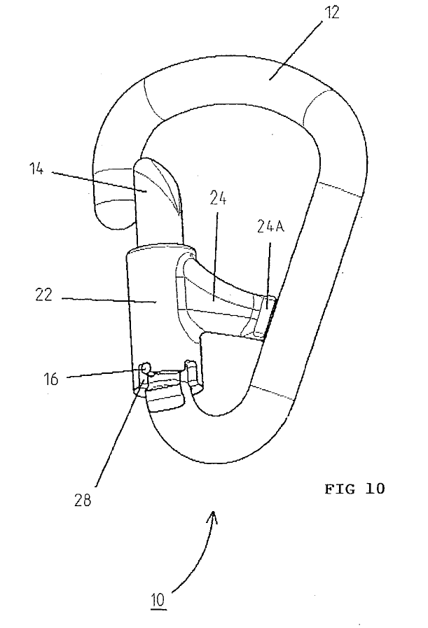

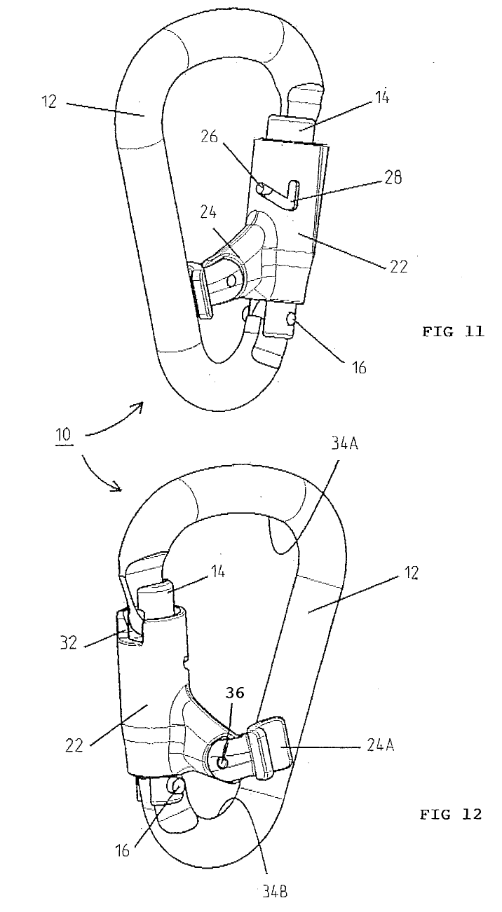

With reference to FIGS. 11 and 13, the aperture 28 of the ring 22 is V-shaped so as to make the ring 22 return automatically to the locked position when the closing travel of the finger 14 takes place. The end of the bar 24 is pivotally mounted on an intermediate spindle 36 so as to prevent relative movement of said bar with respect to the body 12 of the snap-hook 10.

1. A snap-hook comprising:
a fixed hollow C-shaped body having a first end shaped as a retaining part, and a second end on which a mobile finger is articulated around a pivoting spindle between a closed position and an open position,
an operating ring mounted around the finger between a first locked position for positive locking of the finger in the closed position, and a second unlocked position enabling the finger to move to the open position, said ring being able to be moved manually to go from the first locked position to the second unlocked position, and vice-versa,
wherein the operating ring is equipped with a bar salient from the lateral surface to automatically come up against the part of the fixed body situated facing the finger arranging two openings in the body in the first locked position, and that in the second unlocked position, said bar is situated in a different plane from that of the body and defines a single opening in the snap-hook.

2. The snap-hook according to claim 1, wherein the operating ring is equipped with an aperture wherein a pin of the finger engages to determine the movement of said ring.

3. The snap-hook according to claim 2, wherein the pin is formed by the pivoting spindle of the finger.

4. The snap-hook according to claim 2, wherein the aperture comprises two grooves to make the ring bistable in both the locked and the unlocked position.

5. The snap-hook according to claim 2, wherein the aperture is arranged to make the ring monostable in the locked position.

6. The snap-hook according to claim 1, wherein the free end of the bar is provided with a curved bearing face designed to cooperate with the shape of the body.

7. The snap-hook according to claim 1, wherein the finger comprises a latching member situated opposite the spindle to cooperate with the retaining part in the closed position.

8. The snap-hook according to claim 1, wherein the end of the bar is articulated around an intermediate spindle so as to prevent relative movement of said bar with respect to the body.
